(19) United States
(12) Patent Application Publication
(10) Pub. No.: US 2006/0207518 A1
(43) Pub. Date: Sep. 21, 2006

(54) Automatic dog petter

(76) Inventor: Anthony W. Steffen, Melborne, KY (US)

Correspondence Address: William M. Selenke, 5 Drummond St, Cincinnati, OH, 45218, US

(21) Appl. No.: 11/366,721

(22) Filed: Mar. 2, 2006

Related U.S. Application Data
(60) Provisional application No. 60/658,689, filed on Mar. 4, 2005.

(51) Int. Cl. A01K 15/02

(52) U.S. Cl. 119/702

(57) ABSTRACT

The invention is a device to comfort pets such as canines or felines. The device has an L shaped side view shape with a front part that has a sensor means such as a photoelectric cell or activation pads. The sensor activates the petting hand and speaker which reproduces a sound or voice when the pet walks upon the device platform. The sensors are connected in series to a rheostat which controls the rotation speed of electric motor. The electric motor is mechanically connected to a gear box which converts the motion from the motor into arcuate motion. In the preferred embodiment the gear box converts rotational motion from said electric motor into reciprocating arcuate motion with a pitman, crankshaft, journal and a depressed cam cut. In either case the arcuate motion is transferred a rod. A second end of a rod is attached to the hinge end. The rod has a flexible means and a first end. Attached to the first end is a soft artificial hand shaped construct. The artificial hand moves in an arcuate manner to comfort the pet as the voice soothes the pet.

### FIELD OF INVENTION

The invention is concerned with automatic devices that provide artificial petting to comfort household animals such as canines or felines. The animal controls the device by walking onto the petting platform. Likewise the invention is concerned with providing an audio sound or voice, preferably the voice of the dog owner, that provides doggie talk at the same time that the artificial petting machine is petting the dog.

### BACKGROUND OF INVENTION

Domestic canines, like their wolf ancestors, are social and hierarchical animals. Much of the non hunting and eating time is spent to determine each dog's place in the pack. Humans which are surrogate pack leaders for domestic dogs need to interact with their pets. Commonly dogs receive a great deal of petting and other human interactions. It is the nature of the dog that it has a great psychological need for interactions with other creatures whether other dogs or humans.

It is a fact of modern life that most people work away from their homes. If they have pets these pets will often be alone for many hours. This can cause psychological problems for dogs. It is important that the dog receive stimulations the are similar to those received from their human master.

This problem has been well-known. For example U.S. Pat. No. 4,872,422 “Scratching and petting device for household pets” teaches an adjustable mechanical device to scratch and stroke household pets. U.S. Pat. No. 5,540,186 provides an automatic grooming device for animals and U.S. Pat. No. 6,679,858 provides a mechanical massage device for humans. The present invention provides a simple, automatic, and robust device that is automatically activated when the dog stands on platform to receive the petting.

### SUMMARY OF INVENTION

The invention is a device to comfort pets such as canines or felines which has a platform has sensors to detect the pet. The activation means are connected in series to rheostat which controls the rotation speed of electric motor. The electric motor is mechanically connected to a gear box means which converts the motion from the motor into arcuate motion. In a preferred embodiment the gear box converts rotational motion from the electric motor into reciprocating arcuate motion with a pitman, crankshaft, journal and a depressed cam cut. In either case the arcuate motion is transferred a rod. A second end of a rod is attached to the hinge end. The rod has a flexible means and a first end. Attached to the first end is a soft artificial hand shaped construct. Associated with the platform is a sound or voice producing means. The device may be cover in a soft material in a rigid material such a metal or rigid plastic.

### BRIEF DESCRIPTION OF FIGURES

FIG. 1 shows the petting device 10 without the soft cloth cover.

FIG. 2 shows a of the rear view of petting/scratching device 10.

FIG. 3 shows an adjustment collar 54.

FIG. 4 shows a more detailed view of the mechanism of the petting device.

FIG. 5 show the device 10 in action with artificial hand construct 44 petting the workpiece, dog.

FIG. 6 shows a perspective of the automatic dog petter 61 housed in a metal frame/skin

### DETAILED DESCRIPTION OF FIGURES

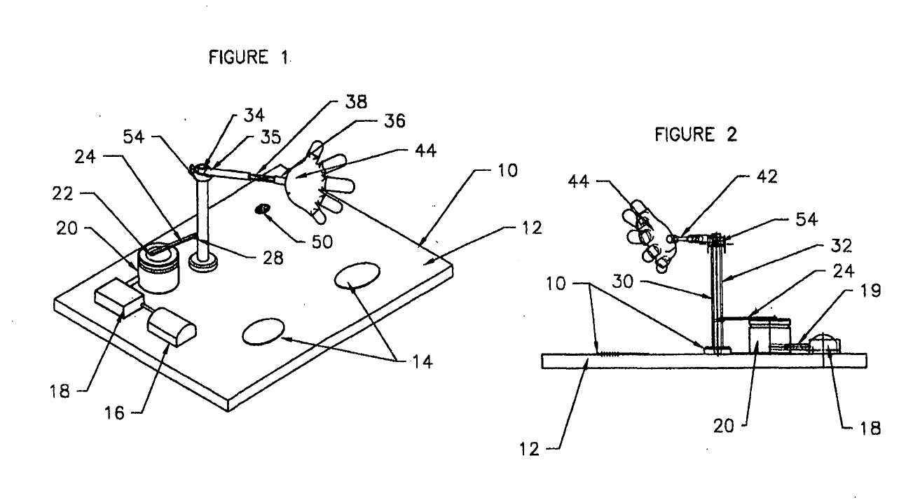

FIG. 1 shows the petting device 10 without the soft cloth cover. Platform 12 has activation pads 14, which pads activate the device. Activation pads 14 (which may be motion detectors) connect in series to rheostat 16 which rheostat controls the rotation speed of electric motor 18. Rheostat 16 would be adjusted by the pet owner for the optimal speed of petting device 10. However, rheostat 16 need not be present if a general appropriate speed were determined. Electric motor 18 is mechanically connected to reducing gear box 20 which gear box connects to crankshaft 22. Rotational motion from crankshaft 22 is transformed into reciprocating motion by pitman 24 to lever 28. Lever 28 connects to journal 30 which is hidden (surrounded) by tube 32. Journal 30 is attached to hinge 34. First end 35 of rod 36 is attached to hinge 34. Rod 34 has a flexible means 38 (in this case the flexible means 38 is a metal spring). Attached to second end 42 of rod 36 is a hand shaped construct 44. A means to produce sound in response to pressure on activation pads 14 is sound box 50.

FIG. 2 shows a of the rear view of petting/scratching device 10. Affixed to platform 12 is electric motor 18. Electric motor 18 is mechanically connected 19 to reducing gear box 20 which gear box connects to crankshaft 22. Rotational motion from crankshaft 22 is transformed into reciprocating motion by pitman 24 to lever 28. Lever 28 connects to journal 30 which is hidden by tube 32. Hand shaped construct 44 is moved in an repeating back and forth motion to mimic hand patting.

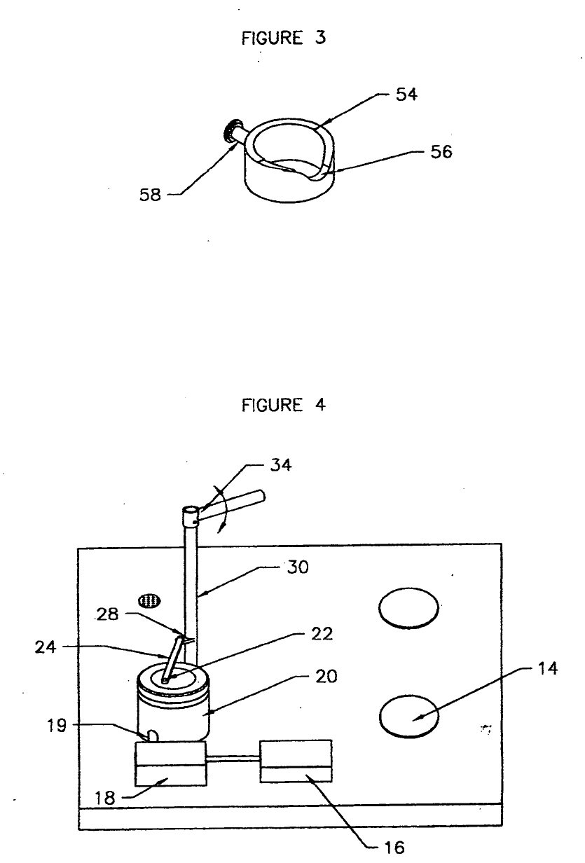

FIG. 3 shows an adjustment collar 54. Adjustment collar 54 is attached to tube 32 at the hinge 34 end. Adjustment collar 54 has a depressed cam cut section 56 to provide a up and down motion to conform to the back of the pet as the artificial hand construct 44 is moved back and forth in a manner stimulating petting. A screw 58 provides an attachment means to adjust the placement of collar 54. The adjustment of color 54 will adjust the distance 62 from the platform 12 to the artificial hand construct 44.

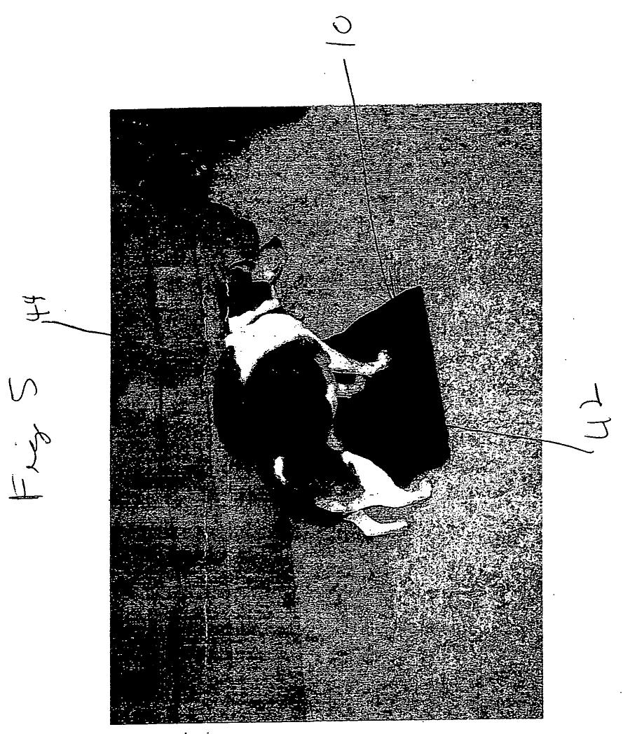

FIG. 4 shows a more detailed view of the mechanism of the petting device. Rheostat 16 controls the rotation speed of electric motor 18. Electric motor 18 is mechanically connected 19 to reducing gear box 20 which gear box connects to crankshaft 22. Rotational motion from crankshaft 22 is transformed into reciprocating motion by pitman 24 to lever 28. Lever 28 connects to journal 30. Journal 30 is attached to hinge 34.

FIG. 5 show the device 10 in action with artificial hand construct 44 petting the workpiece, dog. Device 10 covered with a soft cloth 48

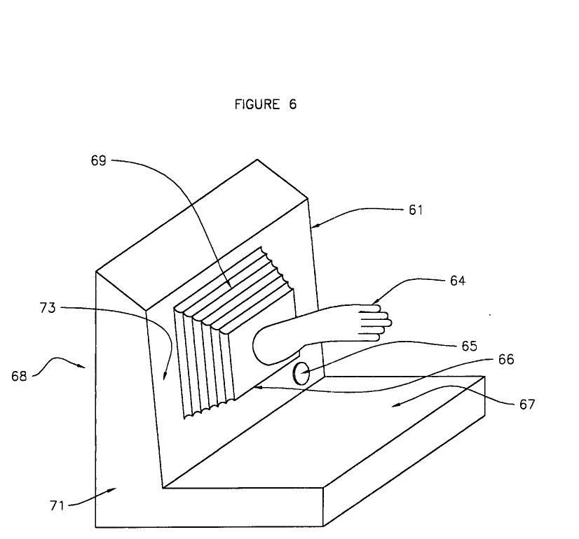

FIG. 6 shows a perspective of the Automatic Dog Petter 61 housed in a metal frame/skin. Housing 61 is construed of metal or sturdy plastic. A side view 71 shows a generally L shape. The upper part of the leg of the L shape is platform 67. The front part of the L shape 73 has the sensor means 66 and the accordion seal. It shows that the present invention can be in different configurations. Petting hand 64 and speaker 65 are shown. The speaker 65 may product sound by any of the well know sound producing means such as a MP3, CD and so forth. A sensor means 66 such as a photoelectric cell actives the petting hand 64 and speaker 65 when the pet walks upon the device 61 platform 67. The controls to control the speed and height of the hand is on the back 68 of the embodiment 61. The mechanical means of producing the petting action of hand 64 is essentially the same as the mechanical device in the embodiment of petting scratching device 10.

While the above embodiment of the present invention is a useful device that has been reduced to practice, it is to be noted that other mechanical/cam systems will provide the arcuate up and down petting motion for the pet dog and provide a confirmations on the outer look that is shown as FIG. 5 and FIG. 6.

I claim:

1) A device to comfort pets such as canines or felines comprising:
An L-shaped side view construct with a platform.
said platform has activation means;
which activation means is connected in series to an adjustable rheostat;
said rheostat controls the rotation speed of an electric motor;
said electric motor is mechanically connected to reducing gear box;
said gear box connects to a mechanical means for providing a reciprocating arcuate motion to a rod;
said rod has a flexible means and a first end and a second end;
attached to said first end is a soft artificial hand shaped construct;
said soft artificial hand shaped construct provides an arcuate petting motion for the workpiece pet.
said second end is attached to said means for providing a reciprocating arcuate motion;
said platform activates an optional adjustable sound or voice producing means.

2) A device to comfort pets such as canines or felines as in claim 1) wherein said device is covered with a soft flexible material.

3) A device to comfort pets such as canines or felines as in claim 1) wherein said device is covered with metal or sturdy plastic

4) A device to comfort pets such as canines or felines as in claim 1) wherein said activation means are pad(s).

5) A device to comfort pets such as canines or felines as in claim 1) wherein said activation means is a photoelectrical cell.

3) A device to comfort pets such as canines or felines comprising;
a platform.
said platform has activation pad(s);
which pad(s) is connected in series to rheostat;
said rheostat controls the rotation speed of electric motor;
said electric motor is mechanically connected to a gear box;
said gear box converts rotational motion from said electric motor into reciprocating arcuate motion with a pitman, crankshaft, journal and a depressed cam cut;
said arcuate motion is transfered a hinged end.
a second end of a rod is attached to said hinge end;
said rod has a flexible means and a first end;
attached to said first end is a soft artificial hand shaped construct;
a sound or voice producing means may be activated when the presence of the pet activates said petting hand.
